(19) United States
(12) Patent Application Publication
(10) Pub. No.: US 2013/0180241 A1
(43) Pub. Date: Jul. 18, 2013

(54) Conveying System for Oil or Gas

(71) Applicants: Volker Middelmann, Crailsheim (DE); Andreas Herrmann, Ellwangen (DE); Maik Tietz, Crailsheim (DE); Daniel Flemmer, Crailsheim (DE); Thomas Vogel, Schillingsfurst (DE); Jurgen Berger, Gerstetten (DE); Stephan Bartosch, Rammingen (DE)

(72) Inventors: Volker Middelmann, Crailsheim (DE); Andreas Herrmann, Ellwangen (DE); Maik Tietz, Crailsheim (DE); Daniel Flemmer, Crailsheim (DE); Thomas Vogel, Schillingsfurst (DE); Jurgen Berger, Gerstetten (DE); Stephan Bartosch, Rammingen (DE)

(73) Assignee: Voith Patent GMBH, Heidenheim (DE)

(21) Appl. No.: 13/812,467

(22) PCT Filed: Feb. 18, 2012
(86) PCT No.: PCT/EP12/00731

§ 371 Date: Apr. 2, 2013

(30) Foreign Application Priority Data
Mar. 4, 2011 (DE) 10 2011 013 115.9

(51) Int. Cl. F02B 47/00

(52) U.S. Cl. CPC F02B 47/00
USPC 60/604

(57) ABSTRACT

The invention concerns a conveyor system for oil or gas
with an engine, which generates an exhaust gas flow 4;
with a conveying device (2) driven by the engine in the form of a pump or compressor, which conveys and/or compresses said oil or said gas;
with an exhaust gas energy recovery device, which converts the heat of the exhaust gas flow (4) into mechanical energy.

The invention is characterised in that
the exhaust gas energy recovery device comprises a working medium circuit (8) with the working medium water, water mixture, ethanol, ethanol mixture, ammoniac or ammoniac mixture, in which a heat exchanger (5) for transmitting the heat of the exhaust gas flow (4) to the working medium, to evaporate said medium partially or completely, include an expansion machine, in which the working medium expands by performing mechanical work, and a condenser (12) for condensation of the working medium is provided, and
the expansion machine is coupled mechanically to the engine and/or the conveying device (2) and/or an additional work machine, to drive it them.

The present invention concerns a conveyor system for oil or gas, having the characteristics as summarized in the preamble of the claim 1.

Oil or gas conveyor systems known in this kind are for instance applied as stationary plants of the oil industry for transporting oil or gas in transport networks, so called pipelines. They include an engine, for driving a conveying device in the form of a pump or of a compressor. The oil or the gas is conveyed by means of the pump or the compressor in the respective pipeline, in which the conveying device is positioned, or from a pipeline into another pipeline or from a pipeline into a storage device or vice versa.

In particular, when using a gas turbine as an engine which itself can be operated with a fraction of the conveyed gas, individual solutions are provided to use the waste heat of the gas turbine in a Clausius-Rankine process which is operated with a refrigerant, for instance R245fa, to generate mechanical energy. Further, approaches are known in which the waste heat of the cooling water of a cooling circuit is profitably used in the conveyor system or a corresponding building.

Due to the necessary adoption of such solutions to the boundary constraints of individual conveyor systems, the corresponding technique was not accepted on the market for want of efficiency, although energy savings can be hence obtained proving advantageously to the environment.

The object of the present invention is to provide a conveyor system for oil or gas, which includes, with respect to conventional installations a better degree of efficiency and provides simultaneously exclusively or almost exclusively series components which can be produced in a cost efficient manner and can be used without a significant amount of adaptation in various plants.

The object of the invention is solved by a conveyor system comprising the features of claim 1.

Advantageous and particularly appropriate embodiments of the invention are disclosed in the dependent claims.

The conveyor system according to the invention for oil or gas includes an engine which generates an exhaust gas flow. Moreover, a conveying device driven by the engine, in the form of a pump or of a compressor is provided for conveying and/or compressing said oil or said gas.

An exhaust gas energy recovery device is moreover provided which converts the heat of the exhaust gas flow into mechanical energy, so as to be able to use it then in the conveyor system.

According to the invention, the exhaust gas energy recovery device includes a working medium circuit with the working medium water, water mixture, ammoniac or ammoniac mixture, whereas a heat exchanger is arranged in the working medium circuit for transmitting the heat of the exhaust gas flow to the working medium so as to evaporate it partially or completely, further an expansion machine in which the working medium expands due to performing of mechanical work, and a condenser for condensation of the working medium, The expansion machine is mechanically coupled to the engine and/or the conveying device and/or an additional work machine, to drive it/them.

According to an alternative embodiment, the working medium includes ethanol or consists mainly or exclusively of ethanol.

According to the working medium utilised, a recuperator can be installed in the working fluid circuit which uses the waste heat in the return line from the expansion machine, to heat the working medium in the feed line of the expansion machine.

The expansion machine is advantageously designed as a reciprocating piston expander, whereas a single and multistage reciprocating piston expander as well as a single and multiflow reciprocating piston expander is appropriate.

Alternately, the expansion machine can be designed as a turbine, for instance as an axial, radial or diagonal turbine. Here also, a single or multistage or a single or multiflow form of embodiment can be considered. As a matter of principle, the expansion machine can also include a constant pressure turbine, also called action turbine or pulse turbine, in which the working medium has the same static pressure or the same enthalpy before and after the rotor. Then, the mechanical work performed originates exclusively from the converting of the kinetic energy. Generally, an expansion device is however connected upstream of such a constant pressure turbine in the working medium circuit for generating the kinetic energy of the working medium.

Further examples for expansion machines, which can be used according to the invention, are screw expanders or scroll expanders, which can comprise one or several stages or one or several flows as well.

The engine can be designed as an internal combustion engine, in particular as a diesel engine, consequently as a motor of the piston type. Alternately, also other engines can be considered, for instance a gas turbine or a gas engine, which are operated advantageously with a fraction of the conveyed gas or of the gas of the conveyor system which is fed for conveying purposes, the gas acting as a combustion medium.

The internal combustion engine can include a crankshaft and the expansion machine is then advantageously in drive connection with the crankshaft or can be switched into such a connection. In particular, the expansion machine is connected directly or only via a separating clutch to the crankshaft and then rotates with the same revolution speed as the engine. Alternately, a transmission is provided between the expansion machine and the engine for instance with a transmission ratio to a lower speed, as seen from the expansion machine.

In an embodiment according to the invention, an electric generator is provided as an additional working machine which is driven by the expansion machine. The expansion machine is advantageously in drive connection with the generator and with the engine or can be connected into such one. This means according to an embodiment that the expansion machine can be switched optionally into a drive connection with the generator or into a drive connection with the engine or into a simultaneous drive connection with both machines (the generator and the engine).

To be able to disengage the expansion machine from the drive train of the conveyor system for maintenance purposes or in case of an accident and hence to avoid any standstill of the conveyor system, the expansion machine is advantageously connected via a detachable, in particular an in operation detachable clutch to the engine and/or the conveying device and/or the additional work machine.

An embodiment according to the invention sets forth that the additional work machine is a cooling device, which can be driven by the expansion machine which cools down the gas or oil conveyed or compressed by the conveying device, in particular once it has been compressed.

The working medium circuit can operate according to an embodiment following the Clausius-Rankine cycle process. A Kalina cycle process can however also be considered. With such a Kalina cycle process, a mixture of ammoniac and water for instance acting as a working medium is evaporated in the heat exchanger, which causes significant pressure increase in the steam as compared to a working medium circuit using water as a working medium. Simultaneously, a decompression in the expansion machine to a pressure lower than the pressure of water as working medium may be effected.

In order to depress the boiling pressure of the working medium, for instance, a concentration variation of the ammoniac concentration may be provided at a given point in the working fluid circuit, in order to reduce the ammoniac concentration. This operation can be performed for instance in a recuperator by adding a lower concentrated ammoniac solution from which ammoniac has been expelled beforehand. This expelling process can be carried out for instance with the waste heat of the waste steam of the expansion machine.

After condensation of the low-ammonia working medium, the expelled portion of ammonia which is the partial flow of working medium enriched with ammonia and in particular separated before the condenser, can be returned to the low-ammonia partial flow for further condensation, either in the condenser or downstream of the condenser in a second condenser.

The feed pump which is advantageously provided in the working medium circuit can be driven by the expansion machine, so as to obtain a self-sustained exhaust gas energy recovery device. It goes without saying that another drive, for instance by means of an electric motor or by means of the engine of the conveying device, is also possible.

The invention will now be described below by way of example using an embodiment.

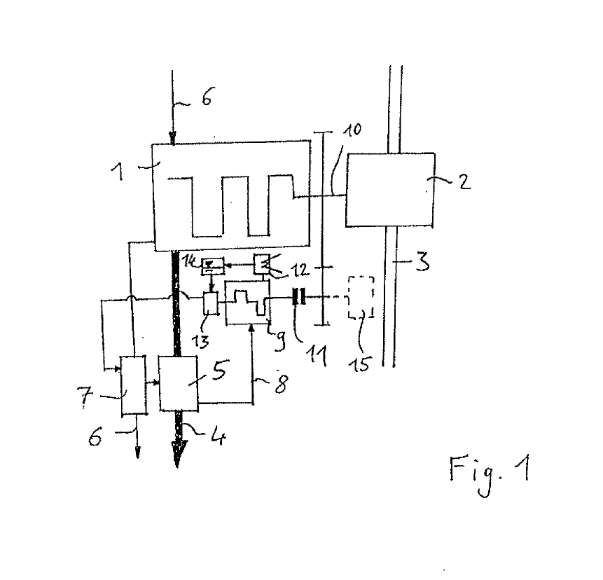

FIG. 1 represents an internal combustion engine 1, which drives the conveying device 2 for conveying oil or gas in a pipeline 3. The internal combustion engine generates an exhaust gas flow 4, in which a heat exchanger 5 is positioned. Besides, the internal combustion engine 1 is cooled by means of a cooling medium flow 6, for instance water, whereas a second heat exchanger 7 is provided in the cooling medium flow 6 upstream of the internal combustion engine 1.

The first heat exchanger 5 dissipates heat from the exhaust gas flow 6. The second heat exchanger dissipates heat from the cooling medium flow 6. The heat dissipated by the second heat exchanger 7 as well as by the first heat exchanger 5 is introduced into the working medium circuit 8, in order to heat up or to evaporate the working medium, here for instance water. For instance, there can be a preheating in the second heat exchanger 7 and the working medium can evaporate in the first heat exchanger 5.

The evaporated working medium is conveyed to the reciprocating piston expander 9, in which it expands due to performing of mechanical work. The reciprocating piston expander 9 is in drive connection with the crankshaft 10 of the internal combustion engine 1, whereas a separating clutch 11 is provided in the illustrated exemplary embodiment in said drive connection. The separating clutch 11 could not only be provided as illustrated here, on the output shaft of the reciprocating piston expander 9 but also at any other location in the drive connection, for instance in the interface or directly before the interface of the drive power introduction to the crankshaft 10.

The working medium expanded in the reciprocating piston expander 9 is condensed in the condenser 12 and by means of a feed water pump 13, which is driven by the reciprocating piston expander 9, is again conveyed to the heat exchangers 7, 5.

In this instance, a storage tank or a compensating container 14 for the working medium, is provided moreover between condenser 12 and feed pump 13 in the working medium circuit 8, which is designed, as here represented, in particular as a continuous-flow container.

As indicated by the dotted lines, the drive power of the reciprocating piston expander 9 can also be used for driving an additional work machine, for instance an electric generator 15, which generates in particular the electrical current or a portion of the electrical current for driving the conveyor system and/or an electric accumulator.

1-10. (canceled)

11. A conveyor system for oil or gas, the conveyor system comprising:
an engine, which generates an exhaust gas flow;
a conveying device driven by the engine in the form of a pump or compressor, which conveys and/or compresses said oil or said gas;
an exhaust gas energy recovery device, which converts the heat of the exhaust gas flow into mechanical energy;
characterised in that
the exhaust gas energy recovery device comprises a working medium circuit with the working medium water, water mixture, ethanol, ethanol mixture, ammoniac or ammoniac mixture, in which a heat exchanger for transmitting the heat of the exhaust gas flow to the working medium to evaporate said medium partially or completely, an expansion machine, in which the working medium expands by performing mechanical work, and a condenser for condensation of the working medium is provided, and
the expansion machine is mechanically coupled to the engine and/or the conveying device and/or an additional work machine, to drive it/them.

12. The conveyor system according to claim 11, characterised in that the expansion machine is designed as a reciprocating piston expander.

13. The conveyor system according to claim 11, characterised in that the engine is designed as an internal combustion engine of the piston type, in particular a diesel engine.

14. The conveyor system according to claim 12, characterised in that the engine is designed as an internal combustion engine of the piston type, in particular a diesel engine.

15. The conveyor system according to claim 13, characterised in that the internal combustion engine includes a crankshaft and the expansion machine is in drive connection with the crankshaft or is switchable into such a connection.

16. The conveyor system according to claim 14, characterised in that the internal combustion engine includes a crankshaft and the expansion machine is in drive connection with the crankshaft or is switchable into such a connection.

17. The conveyor system according to claim 11, characterised in that the expansion machine is connected via a detachable, in particular an in operation detachable coupling to the engine and/or the conveying device and/or the additional work machine.

18. The conveyor system according to claim 12, characterised in that the expansion machine is connected via a detachable, in particular an in operation detachable coupling to the engine and/or the conveying device and/or the additional work machine.

19. The conveyor system according to claim 13, characterised in that the expansion machine is connected via a detachable, in particular an in operation detachable coupling to the engine and/or the conveying device and/or the additional work machine.

20. The conveyor system according to claim 14, characterised in that the expansion machine is connected via a detachable, in particular an in operation detachable coupling to the engine and/or the conveying device and/or the additional work machine.

21. The conveyor system according to claim 15, characterised in that the expansion machine is connected via a detachable, in particular an in operation detachable coupling to the engine and/or the conveying device and/or the additional work machine.

22. The conveyor system according to claim 16, characterised in that the expansion machine is connected via a detachable, in particular an in operation detachable coupling to the engine and/or the conveying device and/or the additional work machine.

23. The conveyor system according to claim 11, characterised in that the additional work machine is an electrical generator and the expansion machine is in particular in mechanical drive connection with the engine and the generator or is switchable into such a connection.

24. The conveyor system according to claim 12, characterised in that the additional work machine is an electrical generator and the expansion machine is in particular in mechanical drive connection with the engine and the generator or is switchable into such a connection.

25. The conveyor system according to claim 11, characterised in that the additional work machine is a cooling device, which cools down the gas or oil conveyed or compressed by the conveying device, in particular once it has been compressed.

26. The conveyor system according to claim 12, characterised in that the additional work machine is a cooling device, which cools down the gas or oil conveyed or compressed by the conveying device, in particular once it has been compressed.

27. The conveyor system according to claim 11, characterised in that the working medium circuit is conducted by the Kalina cycle.

28. The conveyor system according to claim 12, characterised in that the working medium circuit is conducted by the Kalina cycle.

29. The conveyor system according to claim 11, characterised in that the working medium is an ammoniac-water mixture, whose ammoniac concentration is varied in particular by flowing through the working medium circuit by supplying and expelling ammoniac especially by means of a working medium partial flow.

30. The conveyor system according to claim 11, characterised in that a feed pump is provided in the working fluid circuit, by means of which the working fluid is circulated in the working fluid circuit, and the feed pump is driven in particular by the expansion machine.
